(19) United States
(12) Patent Application Publication
(10) Pub. No.: US 2010/0149748 A1
(43) Pub. Date: Jun. 17, 2010

(54) CAR MULTIMEDIA DEVICE WITH IPOD DOCKING AND IPOD SUPPORT BRACKET

(76) Inventor: Pak Wing Lam, Causeway Bay (HK)

Correspondence Address: JOHN ALEXANDER GALBREATH, 2516 CHESTNUT WOODS CT, REISTERSTOWN, MD, 21136, US

(21) Appl. No.: 12/346,932

(22) Filed: Dec. 31, 2008

(30) Foreign Application Priority Data
Dec. 11, 2008 (HK) 08113460.6

(51) Int. Cl. G06F 1/16; H02B 1/01; H01R 13/648

(52) U.S. Cl. 361/679.41; 361/825; 439/607.34

(57) ABSTRACT

The present invention is about a car multimedia device and an iPod support bracket. The said car multimedia device includes a main body, an extendable iPod docking installed in the said main body and a detachable iPod support bracket which can buckle into the slot of the said docking. Insert slots are provided on the slot of the said iPod docking and the said iPod support bracket so that the iPod plug can extend and connect to the iPod player. The said iPod support bracket includes a supporting board. The said supporting board involves an iPod notch on the lower surface of the said supporting board. An insert slot is on the bottom of the said notch for inserting the iPod plug. On the upper surface of the said supporting board, two stoppers extend upward along both left & right sides of the said iPod notch to surround the iPod player. The present invention uses an extendable iPod docking to hold the iPod and a detachable iPod support bracket to provide firm support for the iPod. Therefore, the car multimedia device in the present invention features easy operation, attractive appearance, high stability and adaptability.

### FIELD OF THE INVENTION

The present invention involves a multimedia player, precisely, a car multimedia device with iPod docking and an iPod support bracket.

### BACKGROUND OF THE INVENTION

With the global sale of various iPod musical players, a large number of multimedia devices, for example various audio systems start to introduce iPod player-supporting interfaces. FIG. 1 shows a current player-supporting multimedia device. As shown in FIG. 1, multimedia device 1 has an input terminal 2 to receive external audio/video signals for playing. To play the audio/video contents in iPod 5, a specific external iPod slot 6 needs to be purchased additionally. The specific external iPod slot 6 connects a signal output line 4 and an input terminal 2 on the multimedia player 1 through an output terminal 3 at the end then transfer the audio/video contents stored in iPod 6 to multimedia device 1 for playing. Besides, the specific external iPod slot 6 also needs power supply such as a USB interface 7 to supply power to slot 6.

While used as a car multimedia device, apparently the current solution of connecting the iPod player by a specific external slot has many limitations. First of all, the placing and mounting of the external slot is an issue that needs to be addressed, as a car would produce strong bumping during its starting. Secondly, iPod player can only insert into the slot via the interface at the bottom. This mounting method obviously can not stand the bumping of the car and easily cause the damage at the interface.

### BRIEF SUMMARY OF THE INVENTION

The present invention aims at the technical solution in addressing the above-mentioned limitation of current technology, presenting a car multimedia device which can be firmly inserted into the iPod player and easy to be operated, also, the iPod can be mounted in the iPod docking through a specially-designed iPod support bracket.

The technical solution adopted by the present invention to solve the technical issue is: presenting an iPod support bracket including a supporting board. The said supporting board involves an iPod notch on the lower surface of the said supporting board. There is an insert slot on the bottom of the said notch for inserting the iPod plug. On the upper surface of the said supporting board, two stoppers extend upward along both left & right sides of the said iPod notch to surround the iPod player.

In the side iPod support bracket, there is a back wall on the upper surface of the supporting board for connecting the two stoppers. The upper end of the back wall forms a hanging arm for installing the said iPod support bracket. The external of the said hanging arm extends downward and forms at least two heaves.

In the said iPod support bracket, at least two hooks extend from the front wall of the iPod notch.

In the said iPod support bracket, there is a buckle set at the back of the iPod notch on the lower surface of the said supporting board.

Another technical solution adopted in the present invention to solve the technical problem is: presenting a car multimedia device, including a main body, an extendable iPod docking which is mounted on the main body and a detachable iPod docking which can buckle into the slot on the said docking. Insert slots are provided on the slot of the said iPod docking and the said iPod support bracket so that the iPod plug can extend and connect with the iPod player.

In the said car multimedia device, the said iPod support bracket includes a supporting board which locates on the upper edge of the said slot. The said supporting board has an iPod notch on its lower surface which runs through the said supporting board. The said notch has an insert slot on its bottom for the said iPod plug to extend. On the upper surface of the said supporting board, two stoppers extend upward along both left & right sides of the said iPod notch to surround the iPod player.

In the said car multimedia device, there is a back wall on the upper surface of the supporting board for connecting the two stoppers. The upper end of the back wall forms a hanging arm for installing the said iPod support bracket. The external of the said hanging arm extends downward and forms at least two heaves.

In the said car multimedia device, at least two hooks extend from the front wall of the said iPod notch.

In the said car multimedia device, the said iPod docking includes a sliding bush which is mounted within the main body, an upper cover and a lower cover which is held in the said sliding cover and can move relatively to the said sliding bush. The front of the upper surface of the said upper cover forms the said slot.

In the said car multimedia device, there is a buckle set on the back of the iPod notch of the said supporting board's lower surface and an elastic buckle is mounted on the back of the said slot of the said upper cover's lower surface. The front hook on the said elastic buckle runs through the said slot's back wall to buckle into the said buckle set.

In the car multimedia device, the back of the said upper cover's upper surface forms an annular sliding bush. The said annular sliding bush has the first and second stopping points defining respectively the retracting and extending positions of the iPod docking, a navigating rod—one of its ends can rotate and is installed on the said sliding bush, the other end moves along the said annular sliding bush.

In the said car multimedia device, there is a toothed guide on the said upper cover's upper surface. It meshes with the belt gear on the said sliding bush. There is a pulling spring buckled in the center of the said navigating rod. The other end of the said pulling spring connects with the back of the sliding bush.

The present invention is to improve the current car multimedia device, equipped with an iPod docking which can open (extend) and close (retract) on the main body in order to insert the iPod. It uses a detachable iPod support bracket buckle to provide firm support for the iPod docking. Also, in the car multimedia device of the present invention, different-sized iPod support brackets can be installed in the iPod docking in order to fit the various models and sizes of iPod that users may use. Therefore, the car multimedia device in the present invention features easy operation, attractive appearance, high stability and adaptability.

### BRIEF DESCRIPTION OF THE DRAWINGS

FIG. 1 is the sketch map of the multimedia device's inserting into the iPod player in the current technology;

FIG. 2 is the front view of the car multimedia device's extended status in the iPod docking in The present invention;

FIG. 3 is the side view of the car multimedia device in FIG. 2;

FIG. 4 is the A-A cutaway view of FIG. 2;

FIG. 5 is the planform of the car multimedia device in FIG. 1;

FIG. 6 is the structural sketch map of the iPod support bracket used by the car multimedia device in the present invention;

FIG. 7 is the structural sketch map from another angle of the iPod support bracket in FIG. 5;

FIG. 8 is the structural explosion view of the iPod docking in the present invention;

FIG. 9 is the enlarged view of the portion B in FIG. 4;

FIG. 10 is the enlarged view of the portion C in FIG. 4;

FIG. 11 is the enlarged view of the portion D in FIG. 4;

FIG. 12 is the planform of the retracting status of the car multimedia device in the iPod docking in The present invention;

FIG. 13 is the E-E cutaway view in FIG. 12;

FIG. 14 is the enlarged view of the portion F in FIG. 13.

### DETAILED DESCRIPTION OF THE INVENTION

Below is the further introduction of the present invention, combined with figures and carrying-out example:

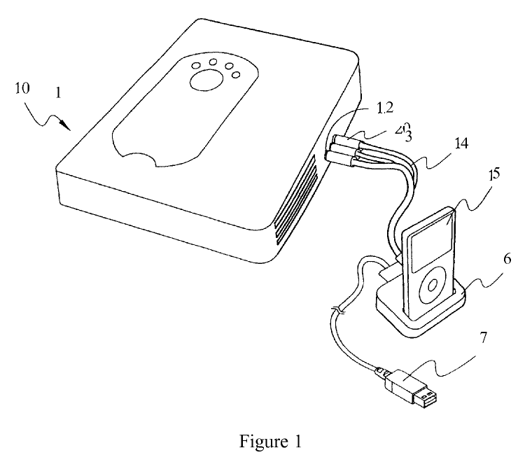

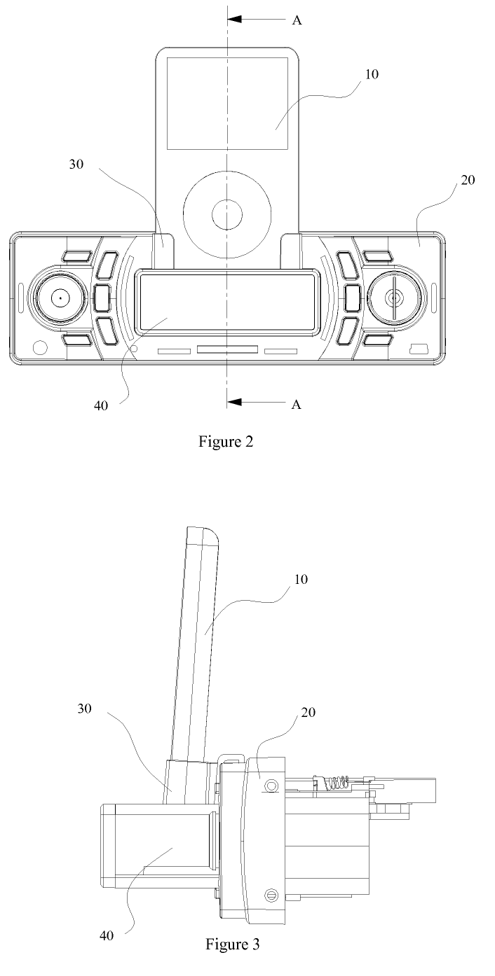

As shown in FIGS. 2 and 3, the car multimedia device in an example of the present invention includes main body 20, extendable iPod docking 40 which is mounted in the main body 20 and a detachable iPod support bracket 30 which buckles into docking 40. An iPod player 10 inserts into support bracket 30 and connects the car multimedia device through a specific iPod interface. AS details shown in FIG. 1, iPod docking 40 is installed in the center of the main body. It drives docking 40 to extend and retract via an extending/retracting mechanism. Detailed structure will be introduced later. Besides, main body 20 can also be equipped with various other components in the current technology, such as FM, volume adjustment, playing control and so on.

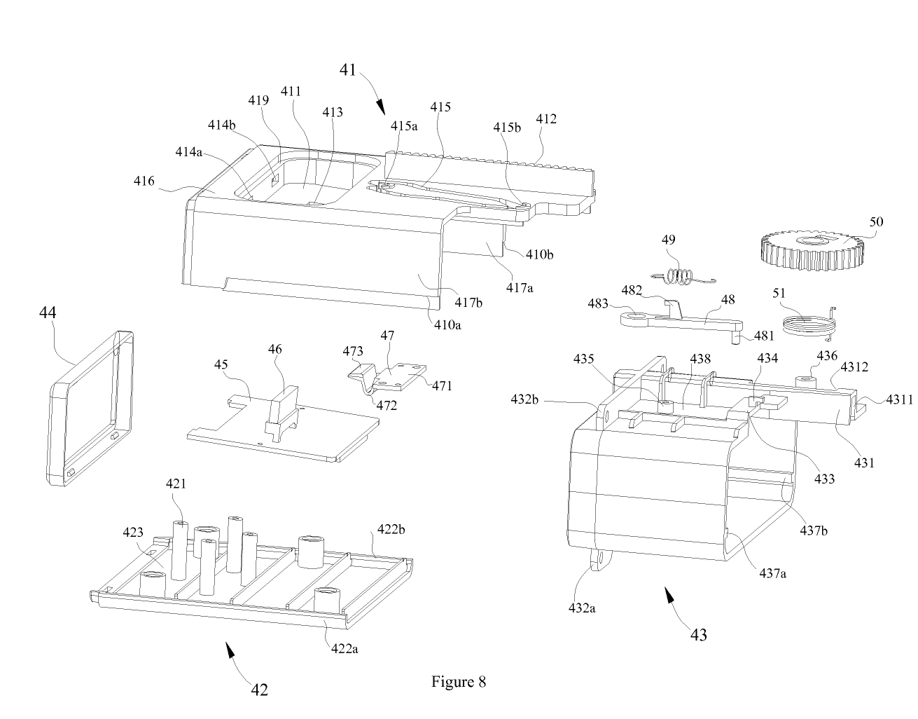

Combined with FIG. 8, following content introduces the detailed structure of iPod docking 40 used by the car multimedia device in the present invention.

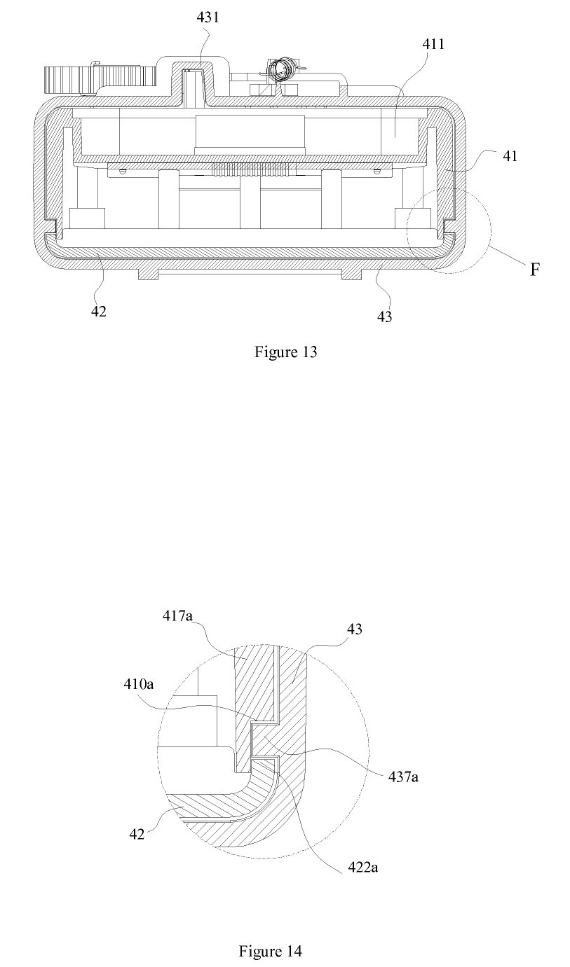

As shown in FIG. 8, iPod docking 40 is mainly composed of an upper cover 41, lower cover 42, a sliding bush 43 and a panel 44. The upper cover 41 has a top board 416 and two side walls 417a and 417b which extend downward from both sides of the top board. The bottom external sides of the two side walls 417a and 417b form steps 410a and 410b. The lower cover 42 has a bottom board 423 and two side walls 422a and 422b which extend upward from both sides of the bottom board 423. The thickness of the lower cover 42's two side walls 422a and 422b corresponding to the steps 410a and 410b that are formed from the bottom of the upper cover 41's two side walls. After the closing-up of upper cover 41 and lower cover 42, slide them into sliding bush 43 (Refer to FIG. 13), the sliding bush 43's two internal side walls form heaves 437a and 437b. Heave 437a/437b embeds into the gap between steps 410a/410b of upper cover 41's side wall bottom and the upper part of lower cover 40's side walls 422a/422b (Refer to FIG. 14), making upper cover 41 and lower cover 42 slide back and forth within sliding bush 43 after their closing up. Also as shown in FIG. 8, panel 44 is installed at the front of the closed upper cover 41 and lower cover 42. Panel 44 includes a decoration ring 441 and a lens 442, joined by LCD 443 located on the bottom board 42, backlight source 444 and display control circuit board 445, providing the display of various information of the car multimedia device.

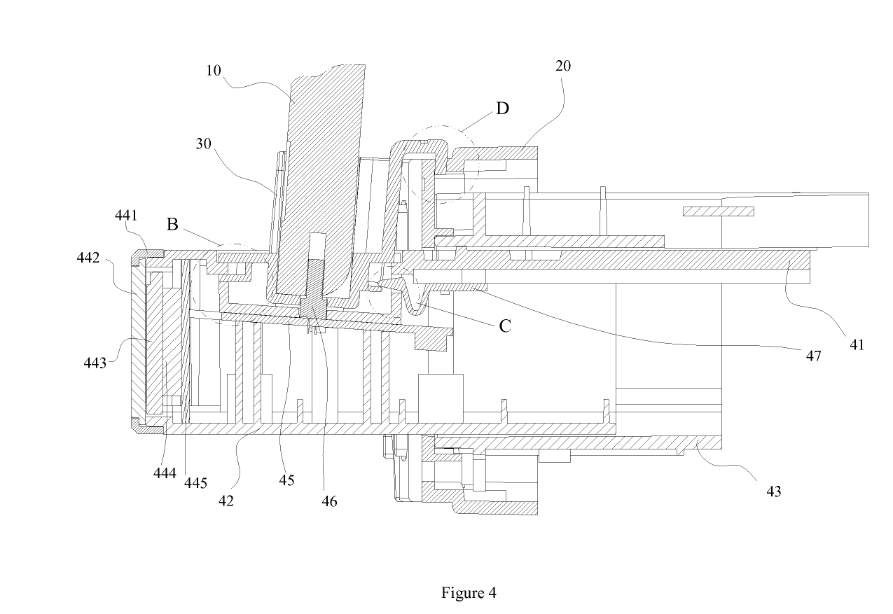

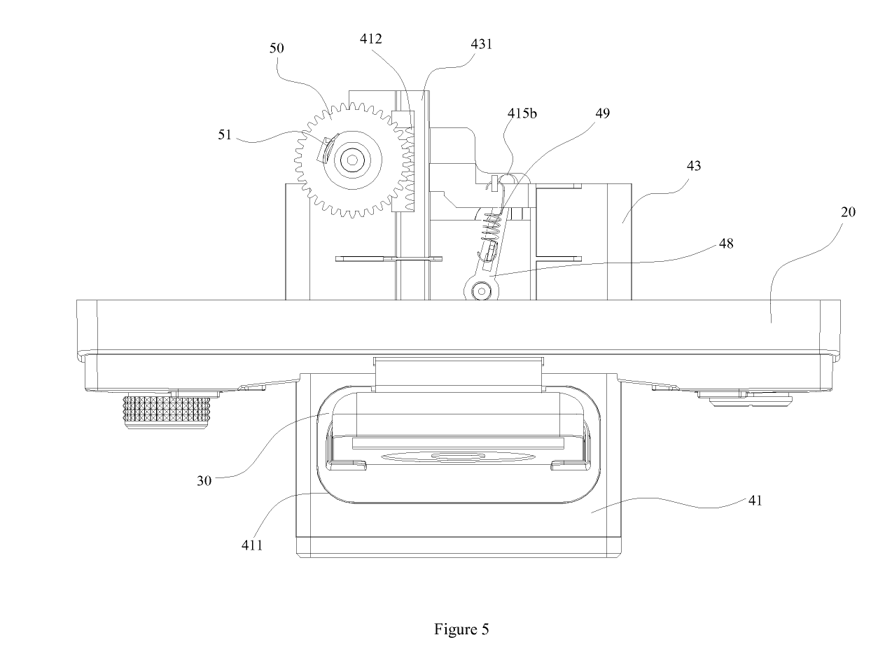

As details shown in FIG. 8, the front of the upper cover 41's top board 461 forms a sinking slot 411. Insert slot 413 locates in the center of slot 411's bottom, for iPod plug 46 of plug-in circuit board 45 to run through in order to connect the interface on the bottom of the iPod player 10 (Refer to FIG. 4). Plug-in circuit board 45 is mounted on the many poles of lower cover 45. The external edge of slot 411 forms joint steps 419. The front side wall of the slot opens two slot 414a and 414b for the installation of the iPod support bracket 30. Detailed introduction will be given later. Besides, the back of upper cover 41's top board 416 has a toothed guide 412. Guide 412 meshes with gear 50 of pole 436 mounted on sliding push 43's surface (Refer to FIG. 5). Also, annular runner 415 forms on the upper cover 41's top board. The first and second stopping points locate on the front and back of the annular runner 415. There is position deflection on the horizontal direction between the first stopping point 415a and the second stopping point 415b.

Refer to FIG. 8 again, sliding bush 43 is used to make upper cover 41 and lower cover 42 to slide within the sliding bush after their closing up. There are mounting sections 432a, 432b on the upper and lower surfaces of the sliding bush's front to mount the sliding bush 43 within main body 20 by screws. Corresponding to guide 412 of upper cover 41, there is a guide cover on sliding bush 43. Guide 412 moves within runner 4311 which is enclosed by guide cover 431. Also, there is a gap 4312 on the back of guide cover 431 in order to let guide 412 in it to come out to mesh with gear 50 (Refer to FIG. 5). At the center of sliding bush 43's upper surface, immediately next to guide cover 431, forms a sinking space 438. Pole 435 extends from sinking space 438. There is also a bridgeware 433 above the back of this sinking space. A navigating rod 48 is mounted on pole 435 via the end axis hole 483 and can rotate around the pole 435. The other end of navigating rod 48 extends from the lower part of the bridgeware 433. The navigating head 481, the other end of navigating rod 48 which is extended downward, is placed in annular runner 415 of the upper cover's upper surface and can move along this annular runner. A spring hook 482 locates at about the center of the navigating rod 48. One end of the pulling spring 49 is hooked on the hook 482. The other end of pulling spring 49 is hooked on spring hook 434 of bridgeware 433.

Combined with FIGS. 5 & 12, a detailed introduction will be given in fellow on the opening (extending) & closing (retracting) movements of the iPod docking used in the car media device of the present invention.

FIG. 5 shows the planform of iPod docking in extending status. In this status, within sliding bush 43, closed upper cover 41 and lower cover 42 (not shown in the figure) move relatively to sliding bush 43 and extend from main body 20. At this time, the slot on upper cover 41 comes out. After mounting iPod support bracket 30, the iPod player can now be inserted. Details as shown in FIG. 5, during upper cover 41's coming out from main body 20, navigating head 481 of navigating rod 48 moves along the trough at the right side of annular runner 415 on upper cover 41 up to second stopping point 415b at the back of annular runner 415 and stops there, keeping the iPod docking in its extending status. At this time, the pulling spring is in its initial status, gear 50 rotates clockwise with guide 412's forward movement, causing spring 51 mounted in gear 50 to deform.

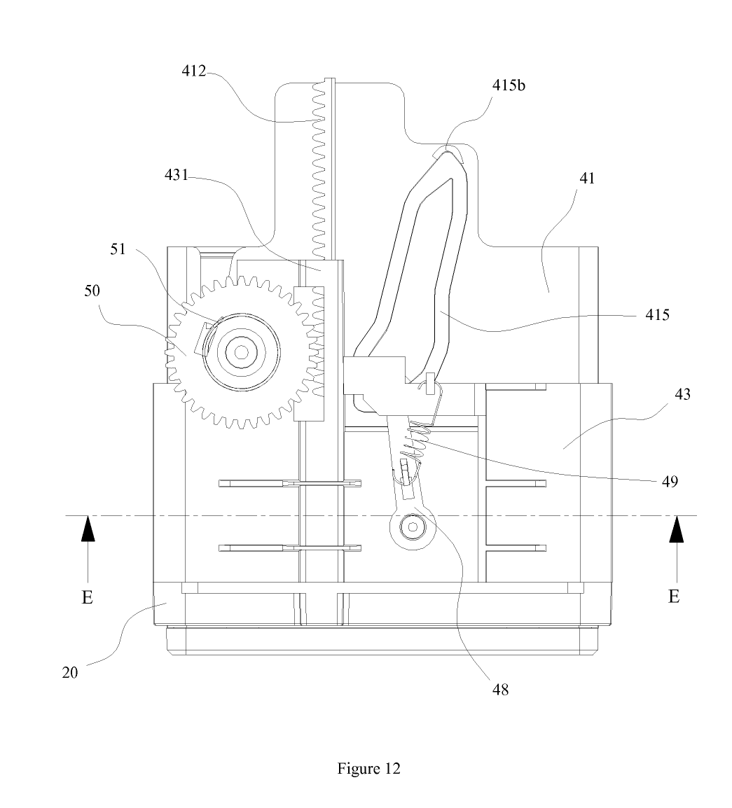

When a user does not need to use the iPod player and wants to turn the iPod docking off, all he/she needs to do is to slightly push the front of the iPod docking inward, letting navigating head 481 of navigating rod 48 to get away from the restriction of second stopping point 415b. Thus, since spring 51 deforms when opening the iPod docking, the elasticity of restoring spring 51 will bring gear 50 to rotate counterclockwise, then drive the meshed guide 412 to move backward, causing upper cover 41 and lower cover 42 which are closed up in sliding bush 43 to slide backward and retract into main body 20, as shown in FIG. 12. During the iPod docking's retracting into the main body from its extending position, navigating head 581 of navigating rod 58 moves along the left trough of annular runner 415 from the second stopping point to the first stopping point at the front of annular runner 415 and stops there, keeping the iPod docking in its closing status. At this time, spring 49 is in its stretching status, as shown in FIG. 12.

When a user needs to use the iPod player and wants to open the iPod docking, he/she only needs to slightly push the front of the iPod docking inward, letting navigating head 481 of navigating rod 48 to get away from the restriction of first stopping point 415a. Thus, the elasticity of restoring pulling spring 49 will bring navigating head 481 of navigating rod 48 to move along the left trough of annular runner 415 from first stopping point 415a to second stopping point 415b, gradually open the iPod docking and keep the opening status when the navigating head of the navigating rod stops at second stopping point 415b. During this process, guide 412 moves forward to drive gear 50 to rotate clockwise, causing spring 51 to rotate.

Combined with the figures, an introduction will be given in below about the extendable iPod docking used by the car multimedia device in an example of the present invention. Obviously, the car multimedia device in the present invention can also use other extending mechanism in current technology to realize the opening and closing of the iPod docking.

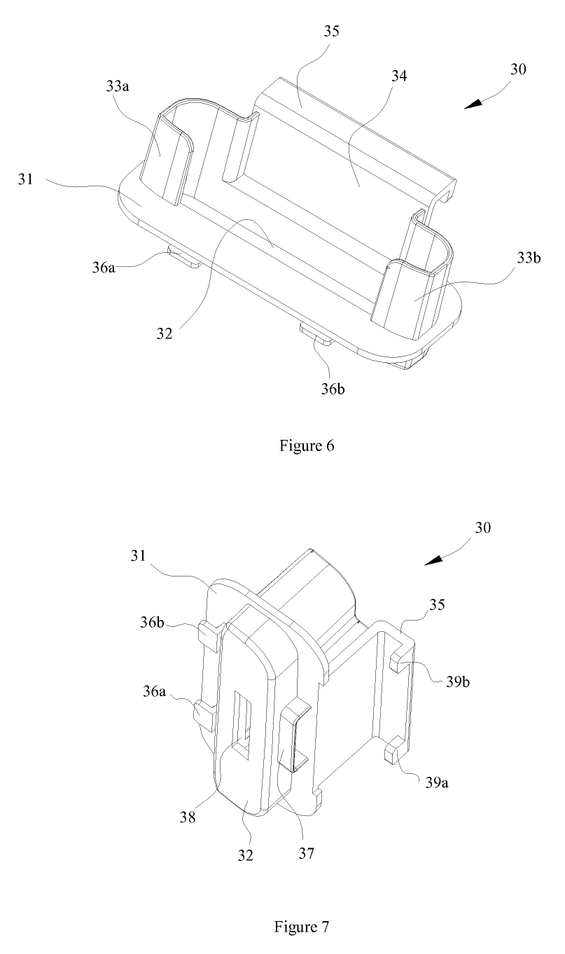

Since the car multimedia device must have good durability for various bumping situations occurred during driving, that is, a reliable connection between the iPod player and the car multimedia device must be maintained. The present invention has a specially designed detachable iPod support bracket to support the iPod player. When a user needs to insert the iPod player into the car multimedia device, he/she may first mount an iPod support bracket whose model and size matches the iPod player on the extended slot of the car multimedia device in order to provide reliable support. When a user doesn't need to use the iPod player and wants to turn it off, he/she can take the iPod support bracket off directly. Combined with FIGS. 6&7, a detailed instruction of the iPod support bracket's structure will be given below.

As shown in FIGS. 6 & 7, iPod support bracket 30 includes a supporting board 31. From the upper surface of supporting board 31, stopper 33a, 33b and back wall 34 extend so that to surround the iPod player. iPod notch 32 locates on the lower surface of supporting board 31 which runs through supporting board 31. Insert slot 38 locates on the bottom of iPod notch 32 so that the iPod plug can run through and connect with the iPod player (Refer to FIG. 4). Details as shown in FIG. 6, iPod notch 32 provides a notch corresponding the profile of the iPod player. The two stoppers 33a and 33b are arranged in symmetry along iPod notch 32, having the similar profile of the iPod player to surround a notch corresponding to the thickness and breadth of the iPod player. Back wall 34 connects the two stoppers 33a and 33b. The upper part of back wall 34 extends horizontally, forming hanging arm 35. The external of hanging arm 35 extends downward, forming two heaves 39a and 39b. Besides, the front wall of iPod notch 32 connects the two hooks 36a and 36b. Hook set 37 locates at the back of iPod notch 32 on the lower surface of supporting board 31.

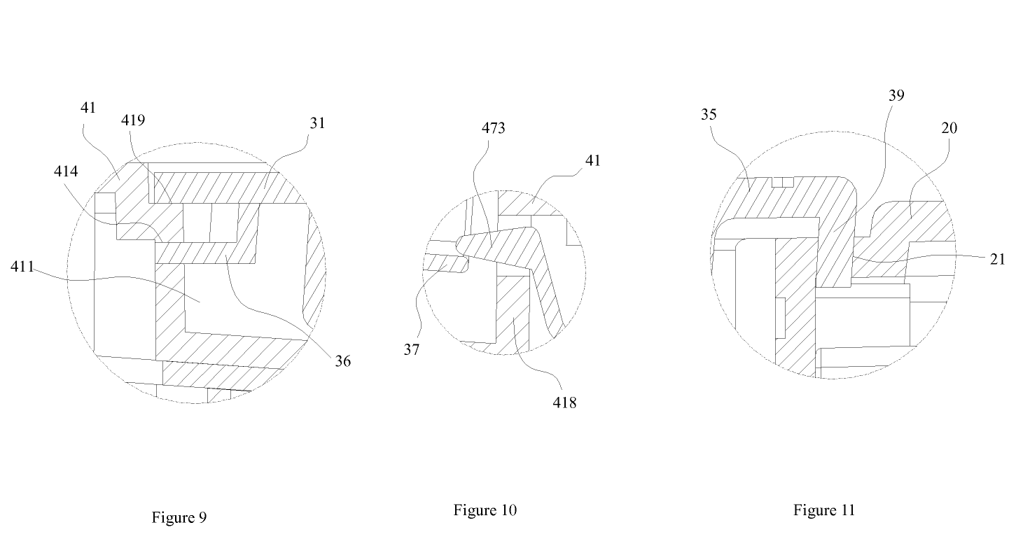

Please refer to FIG. 4 & FIG. 9-11 for the installation of iPod support bracket 30. When inserting iPod support bracket 30 into slot 411 which is formed on upper cover 41, first buckle hook 36 (36a & 36b) which is at the front of iPod support bracket 30 into the corresponding slot 414 (414a & 414b) which is on the front side wall of slot 411, as shown in FIG. 9. Then, buckle heave 39 (39a & 39b) on iPod support bracket 30's hanging arm into slot 21 which is formed at the upper part of main body 20, as shown in FIG. 11. During buckling down iPod support bracket 30, hook 473 of elastic buckle 47 which is mounted on the lower surface of upper cover 41 runs through the gap on back wall 418 of slot 411 and buckles into buckle set 37 of iPod support bracket 30, as shown in FIG. 10. Finally, supporting board 31 positions itself on step 419 which is formed by the external of slot 411. Detailed structure of elastic buckle 47 is shown in FIG. 8, including a faxed flat-board section 471 and a V section 472 which is extended from one side of the fixed section 471. The end of V section 472 forms a hook 473. The elastic buckle is mounted on the lower surface of upper cover 41 through fixed section 471, the elastic deformation generated by V section 472 makes hook 473 either buckle into the buckle set 37 on iPod support bracket 30 or release from it.

Thanks to the above special design, the iPod support bracket used in the present invention may firmly buckle into the iPod docking. iPod specified plug 46 runs through iPod Insert slot 413 within slot 411 on upper cover 41 and iPod Insert slot 38 within iPod notch 32 on the iPod support bracket to connect the interface of iPod player 10. Also, it is very easy to disassemble the iPod support bracket 30, first, pulling out heaves 39a and 39b on the hanging arm, at this time, the elastic buckle will get away from iPod support bracket 30's buckle set 37, then pulling the hooks 36a and 36b at the front of iPod support bracket 30 from the corresponding slots 414a and 414b, the entire iPod support bracket 30 will be removed from slot 411 of upper cover 41.

Combined with an example, above is the introduction of the car multimedia device presented in the present invention and the iPod support bracket it uses. The above description is only a good example of this invention, but not a limitation. All modifications, equivalent alternatives and improvements, as long as in accordance with the concept and principle of this invention, should be included in the

What is claimed is:

1. An iPod support bracket with a supporting board. The said supporting board involves an iPod notch on the lower surface of the said supporting board. An Insert slot is on the bottom of the said notch for inserting the iPod plug. On the upper surface of the said supporting board, two stoppers extend upward along both left & right sides of the said iPod notch to surround the iPod player.

2. According to the said iPod support bracket in claim 1, its feature is that there is a back wall on the upper surface of the supporting board for connecting the two stoppers. The upper end of the back wall forms a hanging arm for mounting the said iPod support bracket. The external of the said hanging arm extends downward and forms at least two heaves.

3. According to the said iPod support bracket in claim 2, its feature is that at least two hooks extend from the front wall of the said iPod notch.

4. According to the said iPod support bracket in claim 3, its feature is that there is a buckle set at the back of the iPod notch on the lower surface of the said supporting board.

5. A car multimedia device includes a main body, an extendable iPod docking which is mounted on the main body and a detachable iPod docking which can buckle into the slot on the said docking. Insert slots are provided on the slot of the said iPod docking and the said iPod support bracket so that the iPod plug can extend and connect with the iPod player.

6. According to the said car multimedia device in claim 5, its feature is that the said iPod support bracket includes a supporting board which locates on the upper edge of the said slot. The said supporting board has an iPod notch on its lower surface which runs through the said supporting board. The said notch has a Insert slot on its bottom so that the said iPod plug can extend. On the upper surface of the said supporting board, two stoppers extend upward along both left & right sides of the said iPod notch to surround the iPod player.

7. According to the said car multimedia device in claim 6, its feature is that the said supporting board has a back wall on its upper surface for connecting the said two stoppers. The upper end of the back wall forms a hanging arm for installing the said iPod support bracket. The external of the said hanging arm extends downward and forms at least two heaves.

8. According to the said car multimedia device in claim 6, its feature is that at least two hooks extends from the front wall of the said iPod notch.

9. According to the said car multimedia device in claim 6, its feature is that the said iPod docking includes a sliding bush which is mounted within the main body, an upper cover and a lower cover which is held in the said sliding bush and can move relatively to the said sliding bush. The front of the upper surface of the said upper cover forms the said slot.

10. According to the said car multimedia device in claim 9, its feature is that there is a buckle set on the back of the iPod notch of the said supporting board's lower surface and an elastic buckle is mounted on the back of the said slot of the said upper cover's lower surface. The front hook on the said elastic buckle runs through the said slot's back wall to buckle into the said buckle set.

11. According to the said car multimedia device in claim 9, its feature is that the back of the said upper cover's upper surface forms an annular sliding bush. The said annular sliding bush has the first & second stopping point, defining respectively the retracting and the extending position of the iPod docking, an navigating rod, one of its ends can rotate and is installed on the said sliding bush and the other end moves along the said annular sliding bush.

12. According to the said car multimedia device in claim 11, its feature is that there is a toothed guide on the said upper cover's upper surface. It meshes with the belt gear on the said sliding bush. There is a pulling spring buckled in the center of the said navigating rod. The other end of the said pulling spring connects with the back of the sliding bush.
